(19) United States
(12) Patent Application Publication
(10) Pub. No.: US 2020/0318023 A1
(43) Pub. Date: Oct. 8, 2020

(54) Aromatic Ester Lubricant for use with Low Global Warming Potential Refrigerants

(71) Applicant: The Lubrizol Corporation, Wickliffe, OH (US)

(72) Inventors: Nicholas Bujouves, Saginaw, MI (US); David M Pallister, Midland, MI (US); Anthony Barthel, Midland, MI (US)

(21) Appl. No.: 16/768,404

(22) PCT Filed: Nov. 29, 2018
(86) PCT No.: PCT/US18/62943

§ 371 Date: May 29, 2020

Related U.S. Application Data
(60) Provisional application No. 62/592,750, filed on Nov. 30, 2017.

(51) Int. Cl. C10M 105/36; C09K 5/04; C10M 105/34; C10M 171/00

(52) U.S. Cl. CPC C10M 105/36; C09K 5/044; C09K 5/042; C10M 105/34; C10M 171/008; C10N 2020/02; C09K 2205/122; C09K 2205/126; C10M 2207/2835; C10M 2207/2845; C10M 2207/2855; C09K 2205/106

(57) ABSTRACT

Working fluids for a low global warming potential (GWP) refrigeration system comprising a compressor. The working fluid may comprise (a) a lubricating oil component comprising (i) at least one aromatic ester comprising the reaction product of an aromatic hydrocarbon having at least one carboxylic functional group and an (mono)alkylalcohol and/or glycol ether; and (b) a refrigerant.

### FIELD OF THE INVENTION

The disclosed technology relates to a working fluid for a low global warming potential (GWP) refrigeration system that includes a compressor, where the working fluid includes an aromatic ester, an optional polyolester oil, and a low GWP refrigerant, wherein the aromatic ester comprises the reaction product of an aromatic hydrocarbon having at least two carboxylic functional groups and a (mono)alkylalcohol and/or a glycol ether. The disclosed technology provides commercially useful working fluids with solubility, miscibility, and viscosity properties suitable for use in refrigeration systems with low GWP refrigerants.

### BACKGROUND OF THE INVENTION

Mechanical refrigeration systems, and related heat transfer devices such as heat pumps and air conditioners, using refrigerant fluids are well known in the art for industrial, commercial and domestic uses. Fluorocarbon based fluids have found widespread use in many residential, commercial and industrial applications as the working fluid in refrigeration systems such as air conditioning, heat pump and organic Rankine cycle systems. Because of certain suspected environmental problems, including the relatively high ozone depletion potential (ODP) or global warming potentials associated with the use of some of the compositions that have heretofore been used in these applications, it has become increasingly desirable to use fluids having low or even zero ozone depletion potential, such as hydrofluorocarbons (“HFCs”), or having both low ODP and low GWP such as hydrofluoroolefins (HFOs) or hydrocarbons (HCs). Furthermore, a number of governments have signed the Kyoto Protocol to protect the global environment, setting forth a reduction of direct and indirect emissions (global warming). Thus, there is a need for non-toxic alternatives to replace certain high global warming potential HFCs.

Thus, there has been an increasing need for new fluorocarbon and hydrofluorocarbon compounds and compositions that are attractive alternatives to the compositions heretofore used in these and other applications. With regard to efficiency in use, it is important to note that a loss in refrigerant thermodynamic performance or energy efficiency may have secondary environmental impacts through increased fossil fuel usage arising from an increased demand for electrical energy. Furthermore, it is generally considered desirable for HFC refrigerant substitutes to be effective without major engineering changes to conventional vapor compression technology currently used with HFC refrigerants.

As the industry has attempted to meet this need, and to provide commercially useful low global warming potential working fluids, it has been found that low global warming potential (GWP) refrigerants have different solubility and miscibility characteristics than traditional HFC refrigerants. As such, many solubility and miscibility problems occur when conventional lubricants that are typically used with HFC refrigerants are now used with low GWP refrigerants. Typically, conventional lubricants, including conventional polyolester (POE) based lubricants, are not believed to be able to provide the miscibility/solubility properties needed to enable these new refrigerant chemistries, to perform satisfactorily and meet the system performance requirements set forth by the hardware manufacturers. Thus, the working fluids based on these low GWP refrigerants are difficult to use and do not perform as well as required, especially when a higher viscosity working fluid is needed since miscibility problems become more pronounced and additional energy is required to pump the higher viscosity fluid.

There is an ongoing need for commercially useful low GWP working fluids based on low GWP refrigerants that do not have the solubility and/or miscibility problems commonly seen in such fluids, and the need is particularly great for higher viscosity fluids and applications.

### SUMMARY OF THE INVENTION

Accordingly, a working fluid for a for a low global warming potential (GWP) refrigeration system comprising a compressor is disclosed. The working fluid may comprise (a) a lubricating oil component comprising (i) at least one aromatic ester comprising the reaction product of an aromatic hydrocarbon having at least one carboxylic functional group and a (mono)alkylalcohol and/or a glycol ether; and (b) a refrigerant.

In some embodiments, the lubricating oil (a) further comprises (ii) at least one polyolester (“POE”) oil, wherein the polyolester oil comprises a polyol esterified with at least one (mono)carboxylic acid that has at least 5 carbon atoms. In yet other embodiments, the polyolester oil comprises a polyol esterified with a mixture of (mono)carboxylic acids, wherein the (mono)carboxylic acids, individually, have 5 to 13 carbon atoms.

The aromatic hydrocarbon used to make the aromatic ester may have 1 to 5, or 1 to 4, or 2 to 4, carboxylic functional groups. In some embodiments, the aromatic hydrocarbon may be an aromatic carboxylic acid, an aromatic polycarboxylic anhydride, an aromatic polycarboxylic ester, or mixtures thereof.

The (mono)alkylalcohol used to make the aromatic ester may comprise at least one C₄ to C₁₅ or C₈ to C₁₃ linear or branched alcohol. In some embodiments, the (mono)alkylalcohol may comprise a C₁₀ and C₁₃ alcohol. In yet other embodiments, the (mono)alkylalcohol may comprises a branched C₁₀ and branched C₁₃ alcohol.

The glycol ether used to make the aromatic ester may comprise alkylene glycols, including mono- and poly-ether alcohols with the general structure of: R₁(—O—R₂)ₓ—OR₃, wherein R₁ and R₃ can individually be hydrogen or a C₁ to C₂ hydrocarbyl group; and where R₂ can be a monoether or a single, alternating, or randomly distributed polyether subunit. Alternatively, the aromatic ester may be a complex ester wherein a doubly uncapped PAG group links two aromatic acids together.

The refrigerant in the working fluid may comprise at least one halogenated carbon compound (“halocarbon”). Suitable halocarbons are not overly limited and can include any carbonaceous compounds that have one or more carbon atoms that are bonded with one or more halogens. In some embodiments, the refrigerant may comprise at least one hydrofluoroolefin, chlorofluoroolefin, hydorochloroolefin, hydrochlorofluoroolefin, hydroolefin, or mixtures thereof. In other embodiments, the refrigerant may comprise at least one hydrofluorocarbon, hydrochlorocarbon, hydrochlorofluorocarbon, chlorofluorocarbon, or mixtures thereof. In yet other embodiments, the refrigerant may comprise carbon dioxide. Alternatively, the refrigerant may comprise at least one hydrocarbon that is an ethane, propane, propene, isobutane, linear butane, pentane, linear pentane, or mixtures thereof.

The polyolester oil, if present in the working fluid, may be present in a ratio of the at least one polyolester oil to the at least one aromatic ester ranging from 95:5 to 5:95. In some embodiments, the ratio of the at least one polyolester oil to the at least one aromatic ester ranges from 60:40 to 40:60. In yet other embodiments, the ratio of the at least one polyolester oil to the at least one aromatic ester is 60:40.

In some embodiments, at least one aromatic ester comprises a benzoate ester, phthalate ester, trimellitate ester, pyromellitate ester, or mixtures thereof. In yet other embodiments, the at least one aromatic ester has the structure of formula (I) or

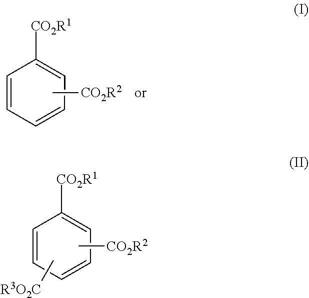

wherein R¹, R², and R³ are individually C₄ to C₁₃ linear or branched hydrocarbyl groups.

If the polyolester oil is present, it may have a neat viscosity ranging from 4 to 400 cSt measured at 40° C. according to ASTM D445. In other embodiments, the neat viscosity may be 200 to 400 cSt, 200 to 350 cSt, 170 to 200 cSt, 100 to 170 cSt, 32 to 120 cSt, 46 to 68 cSt, or 5 to 30 cSt measured at 40° C. according to ASTM D445.

Methods of improving the working viscosity of a working fluid for a refrigeration system are also disclosed. The method may comprise adding a lubricating oil component to a working fluid that comprises a refrigerant. The lubricating component may comprise (i) at least one aromatic ester comprising the reaction product of an aromatic hydrocarbon having at least one carboxylic functional group and a (mono)alkylalcohol and/or a glycol ether.

In some method embodiments, the lubricating oil further comprises (ii) at least one polyolester oil, wherein the polyolester oil comprises a polyol esterified with at least one (mono)carboxylic acid that has at least 5 carbon atoms.

The resulting working fluid may have an improved working viscosity. The working viscosity as used herein is the working fluid's viscosity at a given temperature and pressure. The given temperature and pressure may be representative of the operating conditions of a compressor. Accordingly, the working fluid may have an improved working viscosity at 323 K of at least 40 cSt at 3 bar or at least 8 cSt at 7 bar. In other method embodiments, the resulting working fluid may have an improved working viscosity at 373 K of at least 8 cSt at 10 bar or at least 3 cSt at 20 bar.

In another embodiment, a method of lubricating a compressor is disclosed. The method may include supplying to the compressor a working fluid comprising: (a) a lubricating oil component comprising (i) at least one aromatic ester comprising the reaction product of an aromatic hydrocarbon having at least one carboxylic functional group and a (mono)alkylalcohol and/or a glycol ether; and (b) a refrigerant.

The disclosed working fluid has a low “GWP”. As used herein, “low GWP”, means the working fluid has a GWP value (as calculated per the Intergovernmental Panel on Climate Change's 2014 Fifth Assessment Report) of not greater than about 1300, or a value that is less than 1300, less than 800, or even less than 650. In some embodiments, this GWP value is with regards to the overall working fluid. In other embodiments, this GWP value is with regards to the refrigerant present in the working fluid, where the resulting working fluid may be referred to as a low GWP working fluid.

### BRIEF DESCRIPTION OF THE FIGURES

FIG. 1 is a Solubility Plot for a refrigerant comprising a POE lubricant and an aromatic ester (inventive example).

FIG. 2 is a Viscosity and Vapor Pressure Daniel Plot for a refrigerant comprising a POE lubricant and an aromatic ester (inventive example).

FIG. 3 is a Viscosity and Vapor Pressure Daniel Plot for a refrigerant with a POE lubricant (comparative example).

### DETAILED DESCRIPTION OF THE INVENTION

Various preferred features and embodiments will be described below by way of non-limiting illustration. Working fluids for low global warming potential (GWP) refrigeration system comprising a compressor are disclosed. The working fluids may comprise (a) a lubricating oil component comprising (i) at least one aromatic ester comprising the reaction product of an aromatic hydrocarbon having at least one carboxylic functional group and a (mono)alkylalcohol and/or a glycol ether; and a refrigerant. The lubricating oil components may be used with olefin refrigerants and refrigerant mixtures that contain at least one olefin.

In some embodiments, the lubricating oil (a) further comprises (ii) at least one polyolester (“POE”) oil, wherein the polyolester oil comprises a polyol esterified with at least one (mono)carboxylic acid that has at least 5 carbon atoms. It yet other embodiments, the polyolester oil comprises a polyol esterified with a mixture of (mono)carboxylic acids or their anhydrides, wherein the (mono)carboxylic acids or anhydrides, individually, have 5 to 13 carbon atoms. Suitable ratios of the C₅ to C₁₃ carboxylic acids or anhydrides include but are not limited to 95:5 to 5:95. In yet other embodiments the mixture of (mono)carboxylic acids or their anhydrides comprises at least three C₅ to C₁₃ carboxylic acid or anhydrides. Suitable polyols include, but are not limited to, trimethylolpropane, dipentaerythritol, neopentylglycol, monopentaerythritol, polypentaerythritol, or combinations thereof. In some embodiments, the POE may comprise esters and/or complex esters of aromatic polycarboxylic acids or their anhydrides. The complex ester may be composed of oligomeric units comprised of polyol (which may include, but is not limited to: trimethylolpropane, dipentaerythritol, neopentylglycol, monopentaerythritol, polypentaerythritol), and polyacid or acid anhydride (which may include, but is not limited to: succinic, glutaric, adipic, citric, trimellitic, pyromellitic), or any mixture thereof. The complex ester may be fully or partially capped with functional (mono)carboxylic acids or (mono)alkylalcohols or singly-capped glycol ethers, or any mixture thereof.

As used herein, “(mono)carboxylic” or “(mono)alkylalcohol”, means the (mono) is optional, i.e. the carboxylic or alkyalochol compounds may be mono or poly. In some embodiments of the disclosed technology, however, only monocarboxylic and/or monoalkylalcohols will be present.

In other embodiments, the lubricating oil (a) may comprise other well-known lubricants instead of, or in addition to, the POEs described above. Suitable lubricants can include Groups I-V of the American Petroleum Institute (API) Base Oil Interchangeability Guidelines, namely

| Base Oil | | | | |
|---|---|---|---|---|
| Category | Sulfur (%) | | Saturates (%) | Viscosity Index |
| Group I | >0.03 | and/or | <90 | 80 to 120 |
| Group II | ≤0.03 | and | ≥90 | 80 to 120 |
| Group III | ≤0.03 | and | ≥90 | >120 |

(Groups I, II and III are mineral oil base stocks.)

| | |
|---|---|
| Group IV | All polyalphaolefins (PAOs) |
| Group V | All others not included in Groups I, II, III or IV |

The lubricating oil can comprise mineral or synthetic oils e.g., polyalphaolefin oils and/or polyester oils, and mixtures thereof. In certain embodiments the oil comprises a mineral oil base stock and may be one or more of Group I, Group II, and Group III base oils or mixtures thereof. In certain embodiments the oil is not a synthetic oil. In yet other embodiments the lubricating oil comprise other common base oils, such as alkylbenzene, polyalkylene glycol, and polyvinyl ether.

Suitable aromatic esters are not overly limited. The aromatic hydrocarbon used to make the aromatic ester may have 1 to 5, or 1 to 4, or 2 to 4, carboxylic functional groups. In some embodiments, the aromatic hydrocarbon may be an aromatic carboxylic acid, an aromatic polycarboxylic anhydride, an aromatic polycarboxylic ester, or mixtures thereof. Without limiting the disclosed technology to one theory of operation, it is believed that when the carboxyl group is directly attached to an aromatic ester, the freedom of rotation around that bond is limited. This results in a more rigid molecule with a higher neat viscosity relative to the aromatic esters' molecular weights. In some embodiments, the aromatic ester may be prepared using a polycyclic aromatic acid or acid anhydride, such as 1,8-naphthalic acid.

The (mono)alkylalcohol used to make the aromatic ester may comprise at least one C₄ to C₁₅ or C₈ to C₁₃ linear or branched alcohol. In some embodiments, the (mono)alkylalcohol may comprise a C₁₀ and C₁₃ alcohol. Suitable ratios of the C₁₀ to C₁₃ alcohol include but are not limited to 95:5 to 5:95. In yet other embodiments, the (mono)alkylalcohol may comprises a branched C₁₀ and branched C₁₃ alcohol, i.e. the (mono)alkylalcohol is a mixture of a C₁₀ and C₁₃ alkyl alcohols and both are branched.

The glycol ether used to make the aromatic ester may comprise alkylene glycols, including mono- and poly-ether alcohols with the general structure of: R₁(—O—R₂)ₓ—OR₃, wherein R₁ and R₃ can individually be hydrogen or a C₁ to C₄ hydrocarbyl group; and wherein R₂ can be a monoether or a single, alternating, or randomly distributed polyether subunit. Alternatively, the aromatic ester may be a complex ester wherein a doubly uncapped PAG group links two aromatic acids together.

The refrigerant in the working fluid may comprise at least one halogenated carbon compound (“halocarbon”). Suitable halocarbons are not overly limited and can include any carbonaceous compounds that are have one or more carbon atoms that are bonded with one or more halogens. In some embodiments, the refrigerant may comprise at least one hydrofluoroolefin, chlorofluoroolefin, hydorochloroolefin, hydrochlorofluoroolefin, hydroolefin, or mixtures thereof. In other embodiments, the refrigerant may comprise at least one hydrofluorocarbon, hydrochlorocarbon, hydrochlorofluorocarbon, chlorofluorocarbon, or mixtures thereof. In yet other embodiments, the refrigerant may comprise carbon dioxide. Alternatively, the refrigerant may comprise at least one hydrocarbon that is an ethane, propane, propene, isobutane, linear butane, pentane, linear pentane, or mixtures thereof.

Exemplary hydrofluoroolefins (“HFO”) include, but are not limited to, 2,3,3,3-tetrafluoro-1-propene (R-1234yf), trans-1,3,3,3-tetrafluoro-1-propene (R-1234ze(E)), cis-1,3,3,3-tetrafluoro-1-propene, cis-1,1,1,4,4,4-hexaflouro-2-butene (R-1336mzz(Z)), trans-1,1,1,4,4,4-hexaflouro-2-butene, 1,1-difluoroethylene (R-1132a), trifluoroethylene, trans-1,2-difluoroethene, and cis-1,2-difluoroethene.

Exemplary hydrochlorofluoroolefins (“HCFO”) include, but are not limited to, cis-2,3,3,3-tetrafluoro-1-chloro-1-propene (R-1224yd(Z)), trans-2,3,3,3-tetrafluoro-1-chloro-1-propene, trans-1-chloro-3,3,3-trifluoro-1-propene (R-1233 zd(E)), cis-1-chloro-3,3,3-trifluoro-1-propene, 2-chloro-3,3,3 trifluoropropene, 1,1, dichloro-3,3,3 trifluoropropene, 1,2 dichloro-3,3,3 trifluoropropene (E), and 1,2 dichloro-3,3,3 trifluoropropene (Z).

Exemplary hydrofluorocarbons (“HFC”) such as trifluoromethane (R-23), difluoromethane (R-32), pentafluoroethane (R-125), 1,1,1,2-tetrafluoroethane (R-134a), 1,1,1-trifluoroethane (R-143a), 1,1-difluoroethane (R-152a), 1,2-difluoroethane, 1,1,1,2,3,3,3-heptafluoropropane (R-227ea), 1,1,1,3,3,3-hexafluroropropane (R-236fa), and 1,1,1,3,3-pentafluoropropane (R-245fa).

Exemplary halogenated carbons, include, but are not limited to, tetrafluoromethane (R-14), hexafluoroethane (R-116), octafluoropropane (R-218), trifluoroiodomethane, and trifluorobromomethane.

Exemplary hydrocarbons (“HC”) include, but are not limited to, ethane, ethene (R-1150), propane (R-290), propene (R-1270), isobutane (R-600a), linear butane (R-600), butene, isopentane (R-601a), linear pentane (R-601), and cyclopentane.

Other refrigerants such as carbon dioxide (R-744) and ammonia (R-717) are also suitable.

The polyolester oil, if present in the working fluid, may be present in a ratio of the at least one polyolester oil to the at least one aromatic ester ranging from 95:5 to 5:95. In some embodiments, the ratio of the at least one polyolester oil to the at least one aromatic ester ranges from 60:40 to 40:60. In yet other embodiments, the ratio of the at least one polyolester oil to the at least one aromatic ester is 60:40.

In some embodiments, the at least one aromatic ester comprises a benzoate ester, phthalate ester, trimellitate ester, pyromellitate ester, or mixtures thereof. In yet other embodiments, the at least one aromatic ester may have the structure of formula (I) or (II):

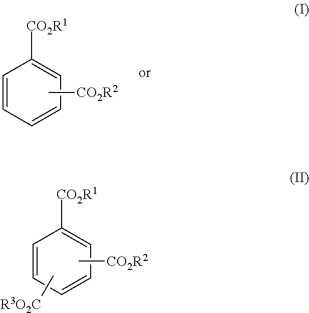

wherein R¹, R², and R³ are individually C₄ to C₁₅ linear or branched hydrocarbyl groups.

In yet other embodiments, the at least one aromatic ester may have the structure of formula (III), (IV) or (V):

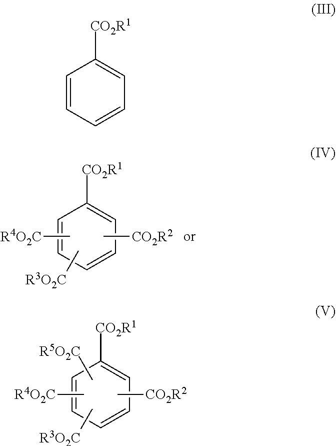

wherein R¹, R², R³, R⁴, and R⁵ are individually C₄ to C₁₅ linear or branched hydrocarbyl groups.

Persons ordinarily skilled in the art will recognize that any combination of the above structures may be suitable for aromatic ester lubricant. Accordingly, in some embodiments, the at least one aromatic ester may have the structure of formula (I), (II), (III), (IV), (V), or combinations thereof. In yet other embodiments, the aromatic ester may comprise at least two aromatic esters having the structure of formulas (II) and (III).

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include:

hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring);

substituted hydrocarbon substituents, that is, substituents containing non-hydrocarbon groups which, in the context of this invention, do not alter the predominantly hydrocarbon nature of the substituent (e.g., halo (especially chloro and fluoro), hydroxy, alkoxy, mercapto, alkylmercapto, nitro, nitroso, and sulfoxy);

hetero substituents, that is, substituents which, while having a predominantly hydrocarbon character, in the context of this invention, contain other than carbon in a ring or chain otherwise composed of carbon atoms and encompass substituents as pyridyl, furyl, thienyl and imidazolyl. Heteroatoms include sulfur, oxygen, and nitrogen. In general, no more than two, or no more than one, non-hydrocarbon substituent will be present for every ten carbon atoms in the hydrocarbyl group; alternatively, there may be no non-hydrocarbon substituents in the hydrocarbyl group.

If the polyolester oil is present, it may have a neat viscosity ranging from 4 to 400 cSt measured at 40° C. according to ASTM D445. In other embodiments, the neat viscosity may be 200 to 400 cSt, 200 to 350 cSt, 170 to 200 cSt, 100 to 170 cSt, 32 to 120 cSt, 46 to 68 cSt, or 5 to 30 cSt measured at 40° C. according to ASTM D445.

The described working fluids may further include one or more performance additives. Suitable examples of performance additives include antioxidants, metal passivators and/or deactivators, corrosion inhibitors, antifoams, antiwear inhibitors, corrosion inhibitors, pour point depressants, viscosity improvers, tackifiers, extreme pressure additives, friction modifiers, lubricity additives, foam inhibitors, emulsifiers, demulsifiers, acid catchers, or mixtures thereof.

In some embodiments, the compositions of the present invention include an antioxidant. In some embodiments, the compositions of the present invention include a metal passivator, wherein the metal passivator may include a corrosion inhibitor and/or a metal deactivator. In some embodiments, the compositions of the present invention include a corrosion inhibitor. In still other embodiments, the compositions of the present invention include a combination of a metal deactivator and a corrosion inhibitor. In still further embodiments, the compositions of the present invention include the combination of an antioxidant, a metal deactivator and a corrosion inhibitor. In any of these embodiments, the compositions may further include one or more additional performance additives.

The antioxidants suitable for use in the present invention are not overly limited. Suitable antioxidants include butylated hydroxytoluene (BHT), butylatedhydroxyanisole (BHA), phenyl-a-naphthyl amine (PANA), octylated/butylated diphenyl amine, high molecular weight phenolic antioxidants, hindered bis-phenolic antioxidant, di-alpha-tocopherol, di-tertiary butyl phenol.

In some embodiments, the antioxidant includes one or more of:
(i) Hexamethylene bis(3,5-di-tert-butyl-4-hydroxyhydrocinnamate), CAS registration number 35074-77-2, available commercially from BASF;
(ii) N-phenylbenzenamine, reaction products with 2,4,4-trimethylpentene, CAS registration number 68411-46-1, available commercially from BASF;
(iii) Phenyl-a- and/or phenyl-b-naphthylamine, for example N-phenyl-ar-(1,1,3,3-tetramethylbutyl)-1-naphthalenamine, available commercially from BASF;
(iv) Tetrakis [methylene(3,5-di-tert-butyl-4-hydroxyhydrocinnamate)] methane, CAS registration number 6683-19-8;
(v) Thiodiethylenebis (3,5-di-tert-butyl-4-hydroxyhydrocinnamate), CAS registration number 41484-35-9, which is also listed as thiodiethylenebis (3,5-di-tert-butyl-4-hydroxy-hydro-cinnamate) in 21 C.F.R. § 178.3570;
(vi) Butylated hydroxytoluene (BHT);
(vii) Butylated hydroxyanisole (BHA),
(viii) Bis(4-(1,1,3,3-tetramethylbutyl)phenyl)amine, available commercially from BASF; and
(ix) Benzenepropanoic acid, 3,5-bis(1,1-dimethylethyl)-4-hydroxy-, thiodi-2,1-ethanediyl ester, available commercially from BASF.

The antioxidants may be present in the composition from 0.01% to 6.0% or from 0.02%, to 1%. The additive may be present in the composition at 1%, 0.5%, or less. These various ranges are typically applied to all of the antioxidants present in the overall composition. However, in some embodiments, these ranges may also be applied to individual antioxidants.

The metal passivators suitable for use in the working fluid are not overly limited and may include both metal deactivators and corrosion inhibitors.

Suitable metal deactivators include triazoles or substituted triazoles. For example, tolyltriazole or tolutriazole may be utilized in the present invention. Suitable examples of metal deactivator include one or more of:
(i) One or more tolu-triazoles, for example N,N-Bis(2-ethylhexyl)-ar-methyl-1H-benzotriazole-1-methanamine, CAS registration number 94270-86-70, sold commercially by BASF under the trade name Irgamet 39;
(ii) One or more fatty acids derived from animal and/or vegetable sources, and/or the hydrogenated forms of such fatty acids, for example Neo-Fat™ which is commercially available from Akzo Nobel Chemicals, Ltd.

Suitable corrosion inhibitors include one or more of:
(i) N-Methyl-N-(1-oxo-9-octadecenyl)glycine, CAS registration number 110-25-8;
(ii) Phosphoric acid, mono- and diisooctyl esters, reacted with tert-alkyl and (C12-C14) primary amines, CAS registration number 68187-67-7;
(iii) Dodecanoic Acid;
(iv) Triphenyl phosphorothionate, CAS registration number 597-82-0; and
(v) Phosphoric acid, mono- and dihexyl esters, compounds with tetramethylnonylamines and C11-14 alkylamines.

In one embodiment, the metal passivator is comprised of a corrosion additive and a metal deactivator. One useful additive is the N-acyl derivative of sarcosine, such as an N-acyl derivative of sarcosine. One example is N-methyl-N-(1-oxo-9-octadecenyl) glycine. This derivative is available from BASF under the trade name SARKOSYL™ O. Another additive is an imidazoline such as Amine O™ commercially available from Ciba-Geigy.

The metal passivators may be present in the composition from 0.01% to 6.0% or from 0.02%, to 0.1%. The additive may be present in the composition at 0.05% or less. These various ranges are typically applied to all of the metal passivator additives present in the overall composition. However, in some embodiments, these ranges may also be applied to individual corrosion inhibitors and/or metal deactivators. The ranges above may also be applied to the combined total of all corrosion inhibitors, metal deactivators and antioxidants present in the overall composition.

To prevent wear on the metal surface, the present invention may utilize an anti-wear inhibitor/EP additive and friction modifier. Anti-wear inhibitors, EP additives, and friction modifiers are available off the shelf from a variety of vendors and manufacturers. Some of these additives can perform more than one task and any may be utilized in the present invention. One product that can provide anti-wear, EP, reduced friction and corrosion inhibition is phosphorus amine salt such as Irgalube 349, which is commercially available from BASF. Another anti-wear/EP inhibitor/friction modifier is a phosphorus compound such as is triphenyl phosphothionate (TPPT), which is commercially available from BASF under the trade name Irgalube TPPT. Another anti-wear/EP inhibitor/friction modifier is a phosphorus compound such as tricresyl phosphate (TCP), which is commercially available from Chemtura under the trade name Kronitex TCP. Another anti-wear/EP inhibitor/friction modifier is a phosphorus compound such as is t-butylphenyl phosphate, which is commercially available from ICL Industrial Products under the trade name Syn-O-Ad 8478. The anti-wear inhibitors, EP, and friction modifiers are typically about 0.1% to about 4% of the composition and may be used separately or in combination.

In some embodiments, the composition further includes an additive from the group comprising: viscosity modifiers-including, but not limited to, ethylene vinyl acetate, polybutenes, polyisobutylenes, polymethacrylates, olefin copolymers, esters of styrene maleic anhydride copolymers, hydrogenated styrene-diene copolymers, hydrogenated radial polyisoprene, alkylated polystyrene, fumed silicas, and complex esters; and tackifiers like natural rubber solubilized in oils.

The addition of a viscosity modifier, thickener, and/or tackifier provides adhesiveness and improves the viscosity and viscosity index of the lubricant. Some applications and environmental conditions may require an additional tacky surface film that protects equipment from corrosion and wear. In this embodiment, the viscosity modifier, thickener/tackifier is about 1 to about 20 weight percent of the lubricant. However, the viscosity modifier, thickener/tackifier can be from about 0.5 to about 30 weight percent. An example of a material that can be used in this invention is Functional V-584, a natural rubber viscosity modifier/tackifier, which is available from Functional Products, Inc., Macedonia, Ohio. Another example is a complex ester CG 5000 that is also a multifunctional product, viscosity modifier, pour point depressant, and friction modifier from Inolex Chemical Co. Philadelphia, Pa.

Methods of improving the working viscosity of a working fluid for a refrigeration system are also disclosed. The method may comprise adding a lubricating oil component to a working fluid that comprises a refrigerant. The lubricating component may comprise (i) at least one aromatic ester comprising the reaction product of an aromatic hydrocarbon having at least one carboxylic functional group and a (mono)alkylalcohol and/or a glycol ether to a refrigerant.

In some method embodiments, the lubricating oil further comprises (ii) at least one polyolester oil, wherein the polyolester oil comprises a polyol esterified with at least one (mono)carboxylic acid that has at least 5 carbon atoms.

The resulting working fluid may have an improved working viscosity at 323 K of at least 40 cSt at 3 bar or at least 8 cSt at 7 bar. In other method embodiments, the resulting working fluid may have an improved working viscosity at 373 K of at least 8 cSt at 10 bar or at least 3 cSt at 20 bar.

In another embodiment, a method of lubricating a compressor is disclosed. The method may include supplying to the compressor a working fluid comprising: (a) a lubricating oil component comprising (i) at least one aromatic ester comprising the reaction product of an aromatic hydrocarbon having at least one carboxylic functional group and a (mono)alkylalcohol and/or a glycol ether; and (b) a refrigerant.

The present methods, systems and compositions are thus adaptable for use in connection with a wide variety of heat transfer systems in general and refrigeration systems in particular, such as air-conditioning (including both stationary and mobile air conditioning systems), refrigeration, heat-pump systems, and the like.

As used herein, the term “refrigeration system” refers generally to any system or apparatus, or any part or portion of such a system or apparatus, which employs a refrigerant to provide cooling and/or heating. Such refrigeration systems include, for example, air conditioners, electric refrigerators, chillers, heat pumps, and the like.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

### Examples

Non-limiting examples of the disclosed working fluids are show in Table 1 below.

TABLE 1
Compositions of lubricants investigated for use with R1234zeE

| | Lubricant Compositions - Polyol, Trimellitate, EXP | | | |
|---|---|---|---|---|
| | | | | R-Group (Chain |
| | Lubricant | | | length of (mono) |
| Exam- | Center | | | carboxylic acid or |
| ple | Group | | | (mono)alkylalcohol) |
| EX 1 | POE | Components | TMP¹:DiPE² | iC9³ |
| EX 2 | POE | Components | TMP:DiPE | iC9 |
| EX 3 | POE | Components | DiPE | nC7⁴:nC8C10:brC9⁵ |
| EX 4 | POE | Components | DiPE | nC5:nC7:brC9 |
| EX 5 | Aromatic | Components | Trimellitate | iC10, iC13 |
| | Ester | | | |
| EX 6 | POE and | Components | Trimellitate | iC10, iC13/ |
| | Aromatic | | 40/DiPE 60 | nC5:nC7:brC9 |
| | Ester | | | |

¹TMP = trimethylolpropane
²DiPE = dipentaerythritol
³i = iso-branched
⁴n = “normal” or linear chain
⁵br = branched

The miscibility of various lubricants in a commercially available refrigerant, R1234ze(E) was tested. For each study, the outer R-groups were kept the same (or similar based on availability), in order to compare how the center group chemistry changes the way that the lubricant interacts with the refrigerant.

Miscibility is measured by placing a known amount of lubricant and refrigerant by wt % in a glass tube, sealing to maintain constant refrigerant gas mass with the lubricant and observing the phase behavior at different temperature increments. Miscibility tubes are heated and/or cooled over a range of temperatures and phase change is monitored. Phases will be recorded as one of the following: 1 is One-Phase Clear—the lubricant and refrigerant are in one phase that is visually clear; HZ is Translucent/Hazy—the lubricant/refrigerant is still one phase, but solution is visually iridescent, or translucent; CL is Cloudy/Milky—the lubricant/refrigerant mixture appears thick, white, or milky, but no distinct phase separation is visible; 2 is Two-Phase Separation—lubricant and refrigerant can be clearly distinguished as two separate phases; FZ is Frozen—frozen particles are visible in the lubricant and/or refrigerant phases.

The miscibility results are shown in Table 2 below.

TABLE 2
Miscibility Relationship of Acid-Centered Lubricants vs Alcohol-Centered Lubricants with R1234ze(E)

| Study # | Study 1 | | | | Study 2 | | Study 3 | | |
|---|---|---|---|---|---|---|---|---|---|
| Lubricant | EX 7 | EX 2 | EX 8 | EX 9 | EX 10 | EX 12 | EX 13 | EX 14 | EX 15 |
| R-Group | iC9 | iC9 | iC9 | iC9 | iC10 | iC10 | nC13 | nC13 | iC13 |
| Center | TMP | TMP:Di | DiPE | Trimellitate | Phthalate | Trimellitate | Adipate | Phthalate | Trimellitate |
| Group | | PE | | | | | | | |
| | | (22:78) | | | | | | | |
| Center | Alcohol | Alcohol:Alcohol | Alcohol | Acid | Acid | Acid | Acid | Acid | Acid |
| Chemistry | | | | | | | | | |
| Linkages | 3 | 3:6 | 6 | 3 | 2 | 3 | 2 | 2 | 3 |
| 40° C. Visc | 52 | 224 | 393 | 84 | 38 | 140 | 27 | 85 | 327 |
| (cSt) | | | | | | | | | |
| VI | 94 | 91 | 88 | 97 | 62 | 79 | 134 | 51 | 70 |
| Lubricant | 9.70% | 10.46% | 9.76% | 9.94% | 9.84% | 10.33% | 9.83% | 10.17% | 10.30% |
| wt % | | | | | | | | | |
| 65° C. | 1 | 1 | 1 | CL | 1 | CL | 1 | 1 | CL/2 |
| 60° C. | 1 | 1 | 1 | CL | 1 | CL | 1 | 1 | CL/2 |
| 55° C. | 1 | 1 | 1 | HZ | 1 | CLT | 1 | 1 | CL/2 |
| 50° C. | 1 | 1 | 1 | 1 | 1 | CLT | 1 | 1 | CL/2 |
| 45° C. | 1 | 1 | 1 | 1 | 1 | CLT | 1 | 1 | CL/2 |
| 40° C. | 1 | 1 | 1 | 1 | 1 | CLT | 1 | 1 | CL/2 |
| 35° C. | 1 | 1 | 1 | 1 | 1 | CLT | 1 | 1 | CL/2 |
| 30° C. | 1 | 1 | 1 | 1 | 1 | CL | 1 | 1 | CL/2 |
| 25° C. | 1 | 1 | 1 | 1 | 1 | CL | 1 | HZ | CL/2 |
| 20° C. | 1 | 1 | 1 | HZ | 1 | CL | 1 | HZ | CL/2 |
| 15° C. | 1 | 1 | 1 | CL | 1 | CL | 1 | CL | CL/2 |
| 10° C. | 1 | 1 | 1 | CL | 1 | CL | 1 | CL | CL/2 |
| 5° C. | 1 | 1 | 1 | CL | 1 | CL | 1 | CL | CL/2 |
| 0° C. | 1 | 1 | 1 | CL | 1 | CL | 1 | CL | CL/2 |
| −5° C. | 1 | 1 | 1 | CL | 1 | CL | 1 | CL | CL/2 |
| −10° C. | 1 | 1 | 1 | CL | 1 | CL | 1 | CL | CL/2 |
| −15° C. | 1 | 1 | 1 | CL/2 | 1 | CL | 1 | CL | CL/2 |
| −20° C. | 1 | 1 | 1 | CL/2 | 1 | CL | 1 | CL | CL/2 |
| −25° C. | 1 | 1 | 1 | CL/2 | 1 | CL | 1 | CL | CL/2* |
| −30° C. | 1 | 1 | 1 | CL/2 | 1 | CL | 1 | CL | CL/2* |
| −35° C. | 1 | 1 | 1 | CL/2 | CL | CL/2 | CL | CL | CL/2* |
| −40° C. | 1 | 1 | 1 | CL/2 | CL | CL/2 | CL | CL | FZ |
| −45° C. | 1 | 1 | 1 | CL/2 | CL | CL/2* | CL | CL* | FZ |
| −50° C. | 1 | 1 | 1 | CL/2 | CL | CL/2* | CL | CL* | FZ |
| −55° C. | 1 | 1 | 1 | CL/2* | CL | FZ | CL | FZ | FZ |
| −60° C. | 1 | 1 | 1 | CL/2* | CL | FZ | CL | FZ | FZ |

1 = One-Phase Clear;
HZ = Translucent/Hazy;
CL = Cloudy/Milky;
2 = Two-Phase Separation;
FZ = Frozen
*Lubricant was beginning to show signs offreezing
†Lubricant cloudiness was reduced, but never reached the clarity of ‘hazy’

Study #1 shows that a trimellitate center reduces the miscibility of the lubricant in the refrigerant. The relationship in Study #2 shows that miscibility changes according to the number of acid groups present on a carboxylic acid-containing aromatic (in this case, benzene ring). Study #3 shows that the structure of the acid, and again the number of ring carboxyl groups, affects the lubricant's miscibility.

Working fluids were prepared by adding the lubricants of Examples EX 4 and EX 6 to a R1234ze(E) refrigerant. The working fluids were tested using a Pressure, Viscosity, and Temperature (“PVT”) apparatus. The PVT apparatus exposes the working fluids to various temperatures and pressures and provides solubility and Daniel plots. Procedures for using PVT apparatuses and generating solubility and Daniel plots are well known in the art but can be generally summarized as follows. A working fluid is gravimetrically charged to the fluid reservoir of the PVT apparatus. The temperature and pressure of the fluid reservoir are changed and controlled with transducers. Once the fluid has been charged, a pump will circulate the fluid through various measurement stages wherein various fluid properties, such as liquid density, solubility, circulating mass flowrate, and liquid viscosity, and vaporization will vary. The PVT apparatus may also have an observation window to allow the user to observe the working fluid during the test. The test conditions are controlled and the data recorded throughout the test through the aid of software. The software then uses the recorded data to generate the solubility and Daniel plots. Additional information for PVT apparatus testing may be found in Seeton, Christopher J. and Hrnjak, Pedrag, 2006, “Thermorphysical Properties of CO2-Lubricant Mixtures and Their Affect on 2-Phase Flow in Small Channels (Less than 1 mm),” International Refrigeration and Air Conditioning Conference. Paper 774.

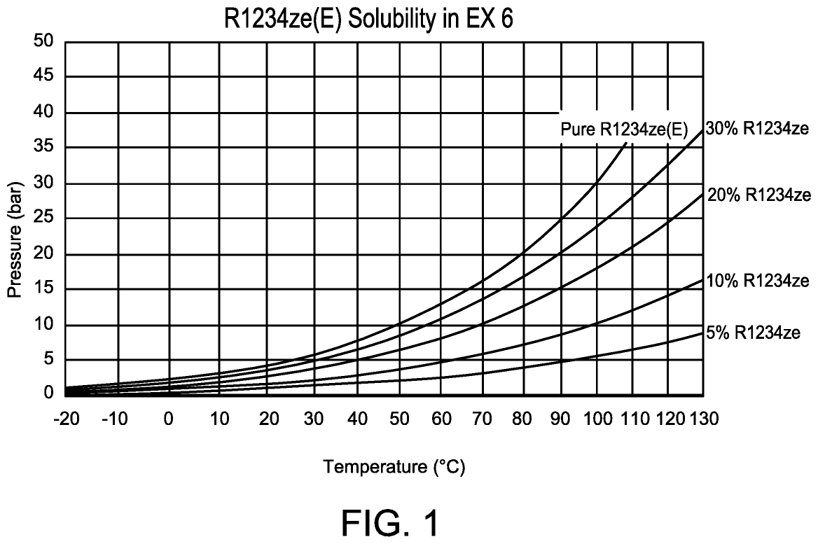

FIG. 1 is a Solubility Plot for various concentrations of a refrigerant comprising a POE lubricant and an aromatic ester (inventive example) at different temperatures. FIG. 1 shows EX 6 is not very soluble in a R1234ze(E) refrigerant, a desired property in a lubricant.

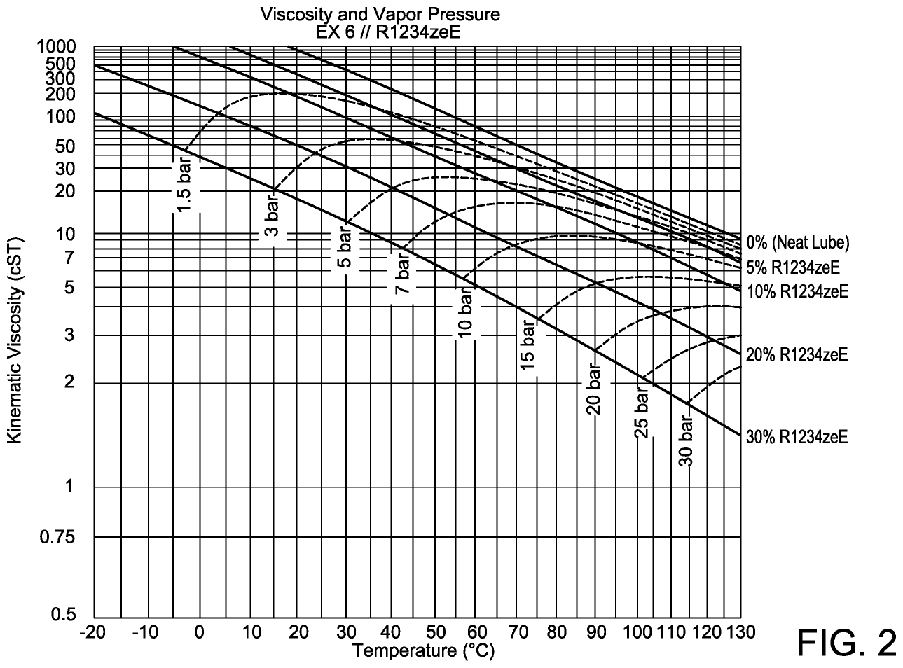

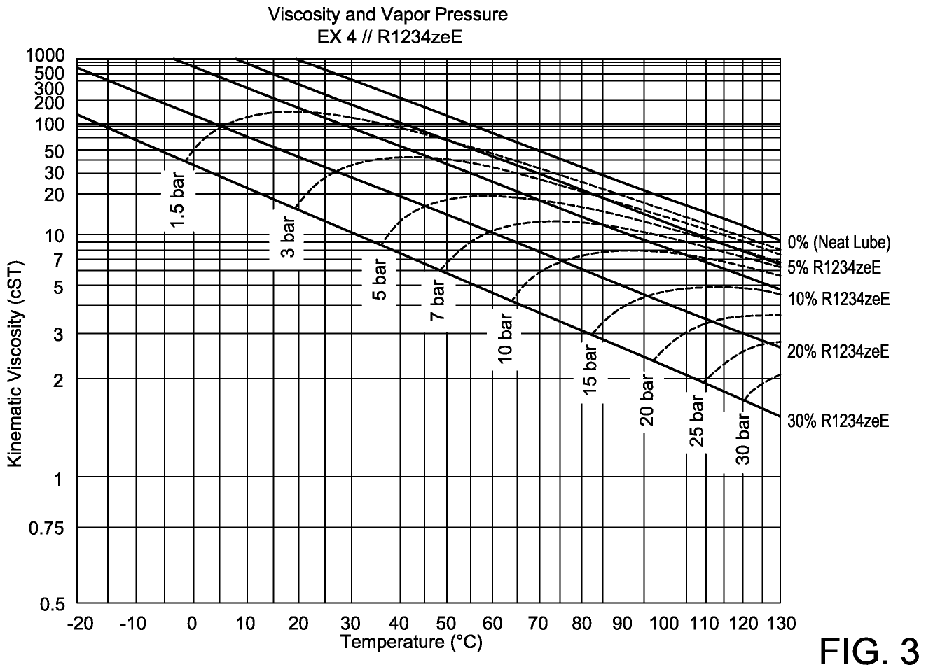

The Daniel plot shows the effect a refrigerant has at different concentrations on a lubricant at a various temperatures and pressures. FIG. 2 is a Viscosity and Vapor Pressure Daniel Plot for a refrigerant comprising a POE lubricant and an aromatic ester (inventive example EX 6). FIG. 3 is a Viscosity and Vapor Pressure Daniel Plot for a refrigerant with a POE lubricant (comparative example EX 4). A comparison of FIG. 2 and FIG. 3 shows that the inventive example, EX 6, has higher kinematic viscosities than the comparative example, EX 4. Table 3 shows the kinematic viscosity for EX 4 and EX 6 at selected temperatures and pressures.

TABLE 3
Kinematic Viscosities of EX 4 and EX 6 in R1234ze(E)

| | | | Working Fluid | Working-Fluid |
|---|---|---|---|---|
| Temperature | | Pressure | Composition | Viscosity |
| (Kelvin) | Lubricant | (bar) | (wt % Refrigerant) | (cSt) |
| 323 | EX 4 | 3 | 9.7840% | 38.9301 |
| | | 7 | 28.4894% | 6.6360 |
| | EX 6 | 3 | 8.0412% | 50.1155 |
| | | 7 | 22.9598% | 11.5545 |
| 373 | EX 4 | 10 | 11.5029% | 7.5616 |
| | | 20 | 27.4455% | 2.5995 |
| | EX 6 | 10 | 9.8310% | 8.8708 |
| | | 20 | 23.4406% | 3.3505 |

The miscibility of various lubricants in other commercially available refrigerants was also tested. The refrigerants included HFC refrigerants difluoromethane (R32), and 1,1,1,2-Tetrafluoroethane (R134a). HFO refrigerants tested were (1E)-1,3,3,3-Tetrafluoro-1-propene R1234ze(E), 2,3,3,3-Tetrafluoroprop-1-ene (R1234yf), (Z)-1,1,1,4,4,4-hexafluoro-2-butene (R1336mzz(Z)). The HCO refrigerant tested was trans-1,2-dichloroethene (R1130(E)). Refrigerant blends were also tested: R450A is an HFO:HFC blend of R134a:R1234ze(E) [42:58]; R513A is an HFC:HFO blend of R134a:R1234yf [44:56]; and R514A is an HFO:HCO blend of R1336mzz(Z):R1130(E) [74.7:25.3]. The miscibility results are shown in the tables below.

Table 4—The ISO220 grouping in Table 4 shows the miscibility of a POE and how it traditionally performed with HFC-134a, where it is now lacking with HFO-1234ze(E), and how the introduction of an ISO220 grade trimellitate can be used to change the miscibility. The ISO100 grouping shows the same pattern, but with a trimellitate in its bulk form.

TABLE 4

| Viscosity | | | | | | | |
|---|---|---|---|---|---|---|---|
| Grade | ISO220 | | | | | | |
| Lubricant | | | TME:POE Mix | | ISO100 | | |
| Center | POE | | Trimellitate:DiPE | | POE | | TME |
| Group | DiPE | | [40:60] | | DiPE | | Trimellitate |
| Refrigerant | R134a | R1234zeE | R134a | R1234zeE | R134a | R1234zeE | R1234zeE |
| Lubricant | 9.12% | 10.17% | 8.92% | 9.87% | 10.18% | 10.03% | 10.22% |
| wt % | | | | | | | |
| 65° C. | 1 | 1 | CL/2 | 1 | 1 | 1 | 1 |
| 60° C. | 1 | 1 | CL/2 | 1 | 1 | 1 | 1 |
| 55° C. | 1 | 1 | CL/2 | 1 | 1 | 1 | 1 |
| 50° C. | 1 | 1 | CL/2 | 1 | 1 | 1 | 1 |
| 45° C. | 1 | 1 | CL/2 | 1 | 1 | 1 | 1 |
| 40° C. | 1 | 1 | CL/2 | 1 | 1 | 1 | 1 |
| 35° C. | 1 | 1 | CL/2 | 1 | 1 | 1 | 1 |
| 30° C. | 1 | 1 | CL/2 | 1 | 1 | 1 | 1 |
| 25° C. | 1 | 1 | CL/2 | 1 | 1 | 1 | 1 |
| 20° C. | 1 | 1 | CL | 1 | 1 | 1 | 1 |
| 15° C. | 1 | 1 | CL | 1 | 1 | 1 | 1 |
| 10° C. | 1 | 1 | CL | 1 | 1 | 1 | 1 |
| 5° C. | 1 | 1 | CL | 1 | 1 | 1 | 1 |
| 0° C. | 1 | 1 | CL | 1 | 1 | 1 | 1 |
| −5° C. | 1 | 1 | CL/2 | 1 | 1 | 1 | 1 |
| −10° C. | CL | 1 | CL/2 | 1 | 1 | 1 | 1 |
| −15° C. | CL | 1 | CL/2 | CL | 1 | 1 | 1 |
| −20° C. | CL | 1 | CL/2 | CL | 1 | 1 | CL |
| −25° C. | CL | 1 | CL/2 | CL | 1 | 1 | CL |
| −30° C. | CL | 1 | CL/2 | CL | 1 | 1 | CL |
| −35° C. | CL | 1 | CL/2 | CL | CL | 1 | CL |
| −40° C. | CL | 1 | CL/2 | CL | CL | 1 | CL |
| −45° C. | CL | 1 | FZ | CL | CL | 1 | CL |
| −50° C. | CL | 1 | FZ | CL | CL | 1 | CL |
| −55° C. | CL | 1 | FZ | CL | CL | 1 | CL |
| −60° C. | CL | 1 | FZ | FZ | CL | 1 | FZ |

1 = One-Phase Clear;
HZ = Translucent Hazy;
CL = Cloudy/Milky;
2 = Two-Phase Separation;
FZ = Frozen

Table 5 R514A is HFO-1336mzz(Z):HCO-1130E [74.7:25.3]—This table shows various trimellitate options for R514A covering a range of viscosities.

TABLE 5
Miscibility of Trimellitate Esters with R514A

| Viscosity | | | | | | |
|---|---|---|---|---|---|---|
| Grade | 50 | 80 | 90 | 140 | 230 | 320 |
| Lubricant | 9.72% | 10.30% | 10.00% | 10.19% | 11.29% | 8.98% |
| wt % | | | | | | |
| 65° C. | 1 | 1 | 1 | 1 | 1 | 1 |
| 60° C. | 1 | 1 | 1 | 1 | 1 | 1 |
| 55° C. | 1 | 1 | 1 | 1 | 1 | 1 |
| 50° C. | 1 | 1 | 1 | 1 | 1 | 1 |
| 45° C. | 1 | 1 | 1 | 1 | 1 | 1 |
| 40° C. | 1 | 1 | 1 | 1 | 1 | 1 |
| 35° C. | 1 | 1 | 1 | 1 | 1 | 1 |
| 30° C. | 1 | 1 | 1 | 1 | 1 | 1 |
| 25° C. | 1 | 1 | 1 | 1 | 1 | 1 |
| 20° C. | 1 | 1 | 1 | 1 | 1 | 1 |
| 15° C. | 1 | 1 | 1 | 1 | 1 | 1 |
| 10° C. | 1 | 1 | 1 | 1 | HZ | CL |
| 5° C. | 1 | HZ | 1 | 1 | CL | CL |
| 0° C. | 1 | CL | 1 | 1 | CL | CL |
| −5° C. | CL | CL | 1 | 1 | CL | CL |
| −10° C. | CL | CL | CL | 1 | CL | CL |
| −15° C. | CL | CL | CL | 1 | CL | CL |
| −20° C. | CL | CL | CL | 1 | CL | CL |
| −25° C. | CL | CL | CL | 1 | CL | CL |
| −30° C. | CL | CL | CL | 2 | 2 | CL |
| −35° C. | 2 | 2 | 2 | 2 | 2 | 2 |
| −40° C. | 2 | 2 | 2 | 2 | 2 | 2 |
| −45° C. | 2 | 2 | 2 | 2 | 2 | 2 |
| −50° C. | 2 | 2 | 2 | 2 | 2 | 2 |
| −55° C. | 2 | 2 | 2 | 2 | 2 | 2 |
| −60° C. | 2 | 2 | 2 | 2 | 2 | 2 |

1 = One-Phase Clear;
HZ = Translucent Hazy;
CL = Cloudy/Milky;
2 = Two-Phase Separation;
FZ = Frozen

Table 6 shows R513A is HFC-134a:HFO-1234yf [44:56]. The ISO32 & ISO100 groupings show how the traditional POE lubricant fails at producing any level of immiscibility with R513A, an HFC:HFO blend, versus the neat trimellitate ester.

TABLE 6

| Viscosity Grade | |
|---|---|
| ISO32 | ISO220 |

Lubricant

| | | | |
|---|---|---|---|
| POE | TME | POE | TME |

Center Group

| | | | |
|---|---|---|---|
| TMP | Trimellitate | DiPE | Trimellitate |

| | Refrigerant | |
|---|---|---|
| Lubricant | R513A | R513A |

| | | | | |
|---|---|---|---|---|
| wt % | 9.56% | 10.07% | 10.07% | 9.90% |

| | | | | | |
|---|---|---|---|---|---|
| 65° | C. | 1 | CL | 1 | CL/2 |
| 60° | C. | 1 | CL | 1 | CL/2 |
| 55° | C. | 1 | HZ | 1 | 2 |
| 50° | C. | 1 | 1 | 1 | 2 |
| 45° | C. | 1 | 1 | 1 | 2 |
| 40° | C. | 1 | 1 | 1 | 2 |
| 35° | C. | 1 | 1 | 1 | 2 |
| 30° | C. | 1 | 1 | 1 | 2 |
| 25° | C. | 1 | 1 | 1 | 2 |
| 20° | C. | 1 | 1 | 1 | 2 |
| 15° | C. | 1 | 1 | 1 | 2 |
| 10° | C. | 1 | 1 | 1 | 2 |
| 5° | C. | 1 | 1 | 1 | 2 |
| 0° | C. | 1 | 1 | 1 | 2 |
| −5° | C. | 1 | CL | 1 | 2 |
| −10° | C. | 1 | CL | 1 | 2 |
| −15° | C. | 1 | CL | 1 | 2 |
| −20° | C. | 1 | CL | 1 | CL/2 |
| −25° | C. | 1 | CL | 1 | CL/2 |
| −30° | C. | 1 | CL | 1 | FZ |
| −35° | C. | 1 | CL | 1 | FZ |
| −40° | C. | 1 | CL | 1 | FZ |
| −45° | C. | 1 | CL | 1 | FZ |
| −50° | C. | 1 | CL | 1 | FZ |
| −55° | C. | 1 | CL/2 | 1 | FZ |
| −60° | C. | 1 | CL/2 | 1 | FZ |

1 = One-Phase Clear;
HZ = Translucent Hazy;
CL = Cloudy/Milky;
2 = Two-Phase Separation;
FZ = Frozen

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

What is claimed is:

1. A working fluid for a refrigeration system comprising:
(a) a lubricating oil component comprising (i) at least one aromatic ester comprising the reaction product of an aromatic hydrocarbon having at least one carboxylic functional group and a(mono)alkylalcohol and/or a glycol ether; and
(b) a refrigerant.

2. The working fluid of claim 1, wherein the lubricating oil further comprises (ii) at least one polyolester oil, wherein the polyolester oil comprises a polyol esterified with at least one (mono)carboxylic acid or (mono)carboxylic anhydride that has at least 5 carbon atoms.

3. The working fluid of claim 2, wherein the polyolester oil comprises a polyol esterified with a mixture of (mono)carboxylic acids or their anhydrides, wherein the (mono)carboxylic acids or their anhydrides, individually, have 5 to 13 carbon atoms.

4. The working fluid of any of the above claims, wherein the aromatic hydrocarbon has 1 to 5, or 1 to 4, or 2 to 4 carboxylic functional groups.

5. The working fluid of any of the above claims wherein the aromatic hydrocarbon is an aromatic carboxylic acid, an aromatic polycarboxylic anhydride, an aromatic polycarboxylic ester, or mixtures thereof.

6. The working fluid of any of the above claims wherein the (mono)alkylalcohol comprises at least one C₄ to C₁₅ linear or branched alcohol.

7. The working fluid of claim 6, wherein the (mono)alkylalcohol comprises a C₁₀ and C₁₃ alcohol.

8. The working fluid of claim 6, wherein the (mono)alkylalcohol comprises a branched C₁₀ and branched C₁₃ alcohol.

9. The working fluid of any of the above claims wherein the at least one aromatic ester comprises the reaction product of an aromatic hydrocarbon having at least one carboxylic functional group and a (mono)alkylalcohol.

10. The working fluid of any of the above claims, wherein the refrigerant comprises at least one hydrofluoroolefin, chlorofluoroolefin, hydorochloroolefin, hydrochlorofluoroolefin, hydroolefin, or mixtures thereof.

11. The working fluid of any of claims 1 to 10, wherein the refrigerant comprises at least one hydrofluorocarbon, hydrochlorocarbon, hydrochlorofluorocarbon, chlorofluorocarbon, or mixtures thereof.

12. The working fluid of any of claims 1 to 10, wherein the refrigerant comprises carbon dioxide.

13. The working fluid of any of claims 1 to 10, wherein the refrigerant comprises at least one hydrocarbon that is an ethane, propane, propene, isobutane, linear butane, pentane, linear pentane, or mixtures thereof.

14. The working fluid of any of claims 2 to 13, wherein the ratio of the at least one polyolester oil to the at least one aromatic ester ranges from 95:5 to 5:95.

15. The working fluid of claim 14, wherein the ratio of the at least one polyolester oil to the at least one aromatic ester ranges from 60:40 to 40:60.

16. The working fluid of claim 15, wherein the ratio of the at least one polyolester oil to the at least one aromatic ester is 60:40.

17. The working fluid of any of the above claims wherein the at least one aromatic ester comprises a benzoate ester, phthalate ester, trimellitate ester, pyromellitate ester, or mixtures thereof.

18. The working fluid of any of the above claims, wherein the at least one aromatic ester as the structure of formula (I) or (II): 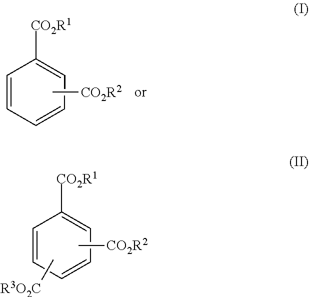
wherein R¹, R², R³ are each individually a C₄ to C₁₅ linear or branched hydrocarbyl groups.

19. The working fluid of any of the above claims wherein the polyolester oil has a neat viscosity of 200 to 400 cSt, 200 to 350 cSt, 170 to 200 cSt, 100 to 170 cSt, 32 to 120 cSt, 46 to 68 cSt, or 5 to 30 cSt measured at 40° C. according to ASTM D445.

20. A compressor charged with the working fluid of any of the above claims.

21. A method of improving the working viscosity of a working fluid for a compressor system, said method comprising adding a lubricating oil component comprising (i) at least one aromatic ester comprising the reaction product of an aromatic hydrocarbon having at least one carboxylic functional group and a (mono)alkylalcohol and/or a glycol ether to a refrigerant.

22. The method of claim 21, wherein the lubricating oil further comprises (ii) at least one polyolester oil, wherein the polyolester oil comprises a polyol esterified with at least one (mono)carboxylic acid that has at least 5 carbon atoms.

23. The method of claim 21 or 22, wherein the working fluid has an improved working viscosity at 323 K of at least 40 cSt at 3 bar or at least 8 cSt at 7 bar.

24. The method of claim 21 or 22, wherein the working fluid has an improved working viscosity at 373 K of at least 8 cSt at 10 bar or at least 3 cSt at 20 bar.

25. A method of lubricating a compressor comprising supplying to the compressor a working fluid comprising:
(a) a lubricating oil component comprising (i) at least one aromatic ester comprising the reaction product of an aromatic hydrocarbon having at least one carboxylic functional group and a (mono)alkylalcohol and/or a glycol ether; and
(b) a refrigerant.
